(19) United States
(12) Patent Application Publication
(10) Pub. No.: US 2012/0216414 A1
(43) Pub. Date: Aug. 30, 2012

(54) Automatic Retractable Chalk Line Box

(76) Inventors: JOHN JONES, MOORCROFT, WY (US); JIMMY ROBERTS, HULETT, WY (US)

(21) Appl. No.: 13/035,268

(22) Filed: Feb. 25, 2011

(51) Int. Cl. B44D 3/38

(52) U.S. Cl. 33/414

(57) ABSTRACT

A chalk box assembly for providing an automated retracting chalk line comprising: a chalk box housing; a spring assembly within the housing; a spool for retaining a chalk line within the housing, where the spring assembly is attached to the spool and provides for the retraction of the chalk line; a chalk compartment within the housing, where chalk is stored within the chalk compartment; and a retraction button engaged with the spring assembly, where the button causes the release of the spring assembly for the retraction of the chalk line. The chalk box assembly according to the present invention may further include a chalk line guide and a chalk fill door. In one particular embodiment of the present invention, the chalk box assembly further includes a belt clip on one side thereof.

### BACKGROUND OF THE INVENTION

1. Field of Invention

The present invention relates to a chalk line box that includes a spring-loaded spool that automatically retracts up to 100 feet of chalk string.

2. Description of Related Art

Chalk boxes are devices used in construction to create a straight line. The chalk box contains a line that is pulled from the box for a substantial amount of length to create a straight line. This chalk boxes are presently used in construction and carpentry and allows the user to draw substantially long, straight lines over an extended distance. The line of a chalk box is usually wound about a reel where the line is covered in chalk. As the line is removed from the reel, the chalk is placed over the surface that the line is placed thereon. Once the line is released it is pulled taut between two points, the chalk is released to create the straight line. The chalk line is retrieved by winding the line back onto the reel of the chalk box. The chalk box includes this reel within the interior compartment and typically the line and reel are wound manually with a hand crank.

Many of the chalk boxes that are available retain moisture and cause the line to tangle as the line is retrieved over the reel. Further, the chalk boxes currently in the prior art have some limitations in their portability and the retractability of the line. One retractable chalk box is disclosed in U.S. Pat. No. 4565011 where the chalk line assembly includes a housing with a pair of compartments with one of the compartments containing a spool having wound thereon a chalk line and a quantity of powder to bathe the spool in chalk line. The other compartment houses a gear arrangement with a helical spring for applying rotational movement for the spool. Another example of a chalk box with a manual cranking reel is disclosed in U.S. Pat. No. 7,624,509, where the chalk box includes a housing a reel, a line, an opening with the line the housing and a removable cap located proximate the opening. Further, the chalk boxes are large devices that aren't convenient to handle and may be limited in retractability.

### SUMMARY OF THE INVENTION

The present invention relates to a chalk box assembly for providing an automated retracting chalk line comprising: a chalk box housing; a spring assembly within the housing; a spool for retaining a chalk line within the housing, where the spring assembly is attached to the spool and provides for the retraction of the chalk line; a chalk compartment within the housing, where chalk is stored within the chalk compartment; and a retraction button engaged with the spring assembly, where the button causes the release of the spring assembly for the retraction of the chalk line. The chalk box assembly according to the present invention may further include a chalk line guide and a chalk fill door. In one particular embodiment of the present invention, the chalk box assembly further includes a belt clip on one side thereof.

### BRIEF DESCRIPTION OF DRAWINGS

FIG. 1 depicts a side view of a retractable chalk box according to the present invention.

FIG. 2 depicts a front view of the retractable chalk box according to the present invention.

### DETAILED DESCRIPTION

The present invention relates to a chalk box assembly that provides an automatic retracting chalk line and therefore eliminates the necessity of a hand crank to wind the chalk line. The chalk box according to the present invention has an automatic windable spring fly reel that retracts the line back into a housing and provides for storage of up to a 100-foot chalk line.

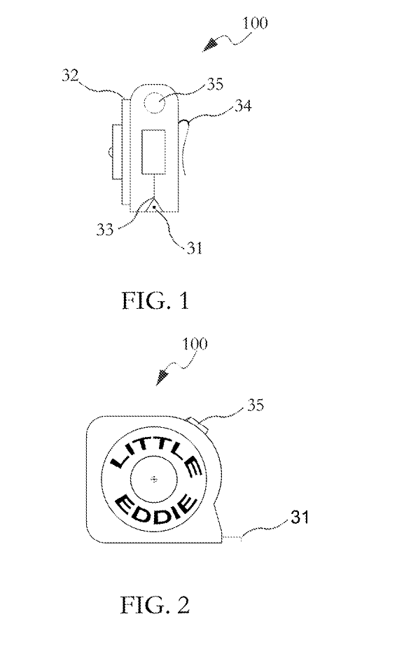

In reference to FIG. 1, a side view of a retractable chalk box 100 according to the present invention is depicted. As shown, the Chalk Box 100 includes a belt clip 34 on one side thereof and a spring coil assembly 32 on the opposite side of the chalk box housing. At the center of the chalk box housing a retractable button 35 is shown that provides the means to automatically retract the chalk line into the housing for storage. Further shown on this side view are a chalk line guide 33 and a chalk fill door 31. The door 31 may be opened so that chalk may be inserted on the interior of the chalk box in a chalk storage compartment within the housing.

The coil assembly 32 includes a coil spring on the interior of the chalk box housing. The coil spring is attached to a spool that holds the chalk line when the line is completely retracted in the chalk box housing. The chalk line is released through the chalk line guide 33 and extended for the desired length to create the marked line. Upon completion of marking the line, the user merely depresses the retraction button 35 and the spring coil retracts the chalk line onto the spool within the housing.

FIG. 2 depicts a front view of the chalk box 100 according to the present invention. As shown the refraction button 35 is depicted on the topside of the chalk box 100 and the chalk line guide is extended from the lower side of the chalk box housing. The spring-loaded spool system within the housing of the chalk box 100 according to the present invention provides an automatic retraction of up to 100 feet of chalk line with the depression of the refraction button 35. The convenience of the chalk box according to present invention is that it may be attached to the belt of a construction worker through the use of the belt clip 34. The chalk box according to the present invention is more compact as opposed to the larger chalk boxes that are known on the prior art and also provides automated retraction of the chalk string. The instant invention has been shown and described in what it considers to be the most practical and preferred embodiments. It is recognized, however, that departures may be made there from within the scope of the invention and that obvious modifications will occur to a person skilled in the art.

What is claimed is:

1. A chalk box assembly for providing an automated retracting chalk line comprising:
a. a chalk box housing;
b. a spring assembly within the housing;
c. a spool for retaining a chalk line within the housing, where the spring assembly is attached to the spool and provides for the retraction of the chalk line;
d. a chalk compartment within the housing, where chalk is stored within the chalk compartment; and
e. a retraction button engaged with the spring assembly, where the button causes the release of the spring assembly for the retraction of the chalk line.

2. The chalk box assembly according to claim 1, where the chalk box assembly further includes a chalk line guide and a chalk fill door.

3. The chalk box assembly according to claim 1, where the chalk box assembly further includes a belt clip on one side thereof.
